(19) United States
(12) Patent Application Publication
(10) Pub. No.: US 2009/0245491 A1
(43) Pub. Date: Oct. 1, 2009

(54) DIGITAL INFORMATION DEVICE AND METHOD FOR PROCESSING CALLS

(75) Inventor: SHAO-YUAN WANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/189,796

(22) Filed: Aug. 12, 2008

(30) Foreign Application Priority Data
Mar. 26, 2008 (CN) 200810300718.7

(51) Int. Cl. H04M 11/00

(52) U.S. Cl. 379/102.03

(57) ABSTRACT

A digital information device enhanced for processing calls between a local user and a remote user includes a transceiving module, a video processing module, and a call processing module. The transceiving module is configured for receiving an incoming call from and transmitting an outgoing call to the remote user. The video processing module is configured for determining a video mode during the incoming call and the outgoing call. The call processing module is configured for selecting one communication terminal from a remote controller and a phone to process the incoming call and the outgoing call and communicating with the remote user via the selected communication terminal in the determined video mode. A method for processing calls is also provided.

### BACKGROUND

1. Field of the Invention

Embodiments of the present disclosure relate to network communications, and more particularly to a digital information device and a method for processing calls.

2. Description of Related Art

With the rapid development of broadband technologies, digital set-top boxes (STBs) employing broadband technologies are now in widespread use. Digital STBs allow users to order and watch a variety of TV programs from the comfort of their homes.

In a digital home network, a local user typically communicates with a remote user via a phone, while controlling an STB and a TV set with a remote controller. When the local user is watching TV with the remote controller in hand and receives an incoming call from the remote user, the local user would have to put down the remote controller and pick up the phone to answer the incoming call, which may be very inconvenient.

Therefore, a heretofore unaddressed need exists in the digital home network to overcome the aforementioned deficiencies and inadequacies.

### SUMMARY

An embodiment of the present disclosure provides a digital information device for processing calls between a local user and a remote user. The digital information device includes a transceiving module, a video processing module, and a call processing module. The transceiving module is configured for receiving an incoming call from and transmitting an outgoing call to the remote user. The video processing module is configured for determining a video mode during the incoming call and the outgoing call. The call processing module is configured for selecting one communication terminal from a remote controller and a phone to process the incoming call and the outgoing call and communicating with the remote user via the selected communication terminal in the determined video mode.

Another embodiment of the present disclosure provides a method for processing calls between a local user and a remote user. The method includes the following blocks: receiving an incoming call and an outgoing call; selecting one communication terminal from a remote controller and a phone to process the incoming call and the outgoing call; determining a video mode during the incoming call and the outgoing call; and communicating with the remote user via the selected communication terminal in the determined video mode.

Other advantages and novel features of the present disclosure will become more apparent from the following detailed description of preferred embodiment when taken in conjunction with the accompanying drawings, in which:

### BRIEF DESCRIPTION OF THE DRAWINGS

FIG. 1 is a schematic diagram of an application environment and functional modules of a digital information device according to one embodiment of the present disclosure;

FIG. 2 is a schematic diagram showing mode changes in processing an incoming call according to one embodiment of the present disclosure;

FIG. 3 is a schematic diagram showing mode changes in processing an outgoing call according to one embodiment of the present disclosure;

FIG. 4 is a flowchart of a method for processing calls according to one embodiment of the present disclosure;

FIGS. 5A and 5B are flowcharts of a method for processing calls according to one embodiment of the present disclosure;

FIG. 6 and FIG. 7 are flowcharts of a method for switching video modes according to one embodiment of the present disclosure; and

FIG. 8 is a flowchart of a method for processing calls according to one embodiment of the present disclosure.

### DETAILED DESCRIPTION OF CERTAIN INVENTIVE EMBODIMENTS

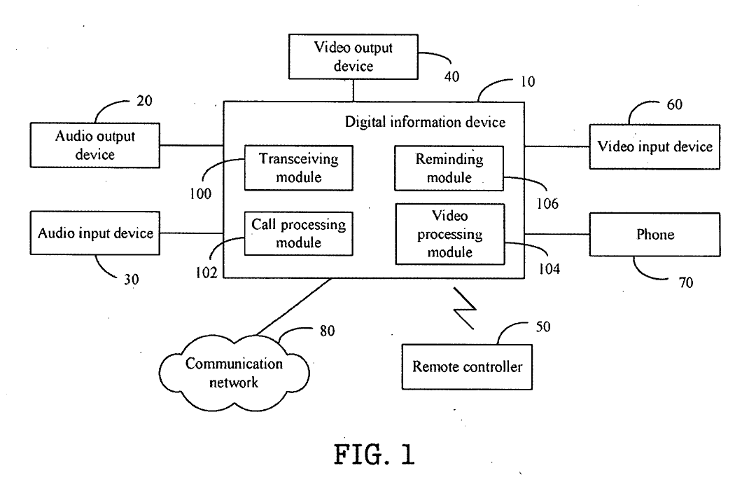

FIG. 1 is a schematic diagram of an application environment and functional modules of a digital information device 10 according to one embodiment of the present disclosure. In one embodiment, the digital information device 10 may be utilized in a digital home network that includes an audio output device 20, an audio input device 30, a video outputting device 40, a remote controller 50, a video input device 60, and a phone 70, which all may be connected to the digital information device 10. In one embodiment, the digital information device 10 may be a set-top box (STB) or a personal computer configured with a television (TV) card. In one embodiment, the audio output device 20 may be a speaker, while the audio input device 30 may be a microphone. In one embodiment, the video output device 40 may be a TV or a display, while the video input device 60 may be a video camera.

The digital information device 10 may receive an incoming call from and/or transmit an outgoing call to a remote user through a communication network 80. Upon the condition that the digital information device 10 receives an incoming call from the remote user through the communication network 80, a local user can either answer the incoming call with the remote controller 50 or the phone 70. Upon the condition that the local user dials an outgoing call, the digital information device 10 transmits the outgoing call to the remote user through the communication network 80. After the remote user has accepted the outgoing call, the local user can either select the remote controller 50 or the phone 70 to process the call.

The digital information device 10 communicates with the remote user via the remote controller 50, the audio input device 30, and the audio output device 20 when the remote controller 50 is selected to process calls. Specifically, the digital information device 10 obtains local audio via the audio input device 30 and transmits the local audio to the remote user through the communication network 80. Simultaneously, the digital information device 10 receives remote audio from the remote user through the communication network 80 and outputs the remote audio via the audio output device 20 to the local user.

The digital information device 10 communicates with the remote user via the phone 70 when the phone 70 is selected to process calls. Specifically, the digital information device 10 obtains local audio via the phone 70 and transmits the local audio to the remote user through the communication network 80. Simultaneously, the digital information device 10 receives remote audio from the remote user through the communication network 80 and outputs the remote audio via the phone 70 to the local user.

Additionally, the digital information device 10 further provides video service for the local user. In one embodiment, the digital information device 10 provides video service for the local user via the video input device 60 and the video output device 40. Specifically, the digital information device 10 obtains local video via the video input device 60 and transmits the local video to the remote user through the communication network 80. Simultaneously, the digital information device 10 receives remote video from the remote user through the communication network 80 and outputs the remote video via the video output device 40 to the local user.

In one embodiment, the digital information device 10 includes a transceiving module 100, a call processing module 102, and a video processing module 104.

The transceiving module 100 is configured for receiving an incoming call from and/or transmitting an outgoing call to the remote user. In one embodiment, the transceiving module 100 may receive an incoming call from the remote user or receive an outgoing call request from the local user.

In one embodiment, the local user may dial an outgoing call via the phone 70, and subsequently, the transceiving module 100 transmits the outgoing call to the communication network 80.

In other embodiments, the local user may dial the outgoing call via the remote controller 50. In this case, both the remote controller 50 and the digital information device 10 contain dialing software, allowing the local user to dial the outgoing call via the remote controller 50.

Preferably, the digital information device 10 further includes a reminding module 106 configured for notifying the local user of an incoming call. In this embodiment, the reminding module 106 makes the phone 70 ring in order to notify the local user of the incoming call when the transceiving module 100 receives the incoming call from the communication network 80.

It may be understood that the reminding module 106 is not restricted to notifying the local user of an incoming call via the phone 70, but the reminding module 106 may also notify the local user of an incoming call via the video output device 40 or the audio output device 20. For example, the reminding module 106 may control the video output device 40 to display a dialog in order to notify the local user of an incoming call when the video output device 40 has been turned on. The reminding module 106 may control the video output device 40 to be automatically turned on in order to notify the local user of an incoming call when the video output device 40 has been turned off. The reminding module 106 may also control the audio output device 20 to generate an audio alert in order to notify the local user of an incoming call.

The video processing module 104 is configured for determining a video mode during the call received by the transceiving module 100. In one embodiment, the video mode includes on and off video modes.

The video processing module 104 is further configured for selecting a privacy mode to determine if a local video is to be transmitted to the remote user. In one embodiment, the privacy mode includes on and off modes. The video processing module 104 does not transmit the local video to the remote user when the privacy mode is on.

The video processing module 104 transmits local video to the remote user when the privacy mode is off. In this case, the video processing module 104 controls the video input device 60 to obtain the local video and transmits the local video to the digital information device 10. Then, the digital information device 10 transmits the local video to the remote user via the communication network 80.

The video processing module 104 is further configured for receiving a video switching instruction for turning on/off the video mode. In one embodiment, the remote controller 50 includes a video switching button on a keyboard of the remote controller 50, and the local user can switch the current video mode by pressing the video switching button. For instance, the remote controller 50 transmits a video switching instruction to the digital information device 10 when the current video mode is on and the local user presses the video switching button of the remote controller 50. Subsequently, the video processing module 104 receives the video switching instruction and turns off the video mode based on the video switching instruction. Conversely, the remote controller 50 transmits a video switching instruction to the digital information device 10 when the current video mode is off and the local user presses the video switching button of the remote controller 50. In this case, the video processing module 104 receives the video switching instruction and turns on the video mode based on the video switching instruction.

The call processing module 102 is configured for determining one communication terminal to process the call, and communicating with the remote user via the communication terminal in the determined video mode. In one embodiment, the communication terminal includes the remote controller 50 and the phone 70. The call processing module 102 communicates with the remote user in the determined video mode via the remote controller 50 when the remote controller 50 is selected to process the call, and communicates with the remote user in the determined video mode via the phone 70 when the phone 70 is selected to process the call.

The call processing module 102 communicates with the remote user via the communication terminal with the audio and video on when the video mode is on, and communicates with the remote user via the communication terminal with only the audio on when the video mode is off.

The call processing module 102 is further configured for determining if the incoming call is accepted by the local user when the transceiving module 100 receives an incoming call from the remote user through the communication network 80, and for determining if the remote controller 50 or the phone 70 is selected to process the incoming call when the incoming call is accepted by the local user. In one embodiment, the call processing module 102 receives a rejecting command when the local user sends the rejecting command via the remote controller 50 or the phone 70, and determines that the incoming call is not accepted by the local user according to the rejection command. The call processing module 102 receives an accepting command when the local user sends the accepting command via the remote controller 50, determines that the incoming call is accepted by the local user, and determines that the remote controller 50 is selected to process the incoming call. The call processing module 102 receives an accepting command when the local user sends the accepting command via the phone 70, determines that the incoming call is accepted by the local user, and determines that the phone 70 is selected to process the incoming call.

The video processing module 104 is further configured for automatically turning on the video mode and the privacy mode when the transceiving module 100 receives an incoming call from the remote user over the communication network 80 and the remote controller 50 is selected to process the incoming call. The video processing module 104 is further configured for inquiring the local user if the video mode needs to be turned on when the transceiving module 100 receives an incoming call from the remote user over the communication network 80 and the phone 70 is selected to process the incoming call.

The call processing module 102 is further configured for determining if the outgoing call is accepted by the remote user when the transceiving module 100 receives an outgoing call from the remote controller 50 or the phone 70, and further configured for determining if the remote controller 50 or the phone 70 is selected to process the outgoing call when the outgoing call is accepted by the remote user. The video processing module 104 is further configured for automatically turning on the video mode and determining the privacy mode based on the initial settings when the remote controller 50 is selected to process the outgoing call. The video processing module 104 turns off the video mode when the phone 70 is selected to process the outgoing call.

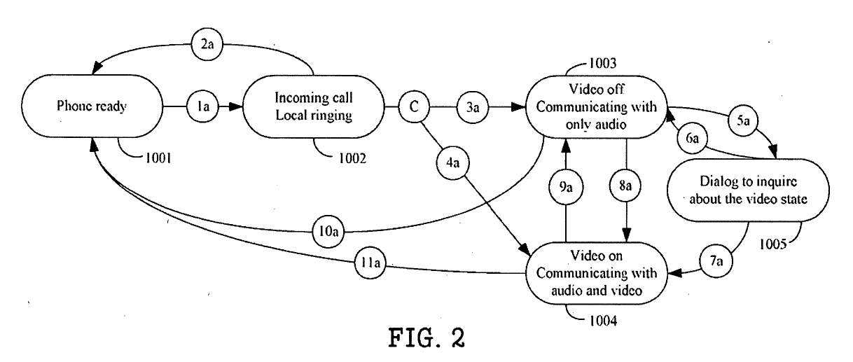

FIG. 2 is a schematic diagram showing mode changes in processing an incoming call according to one embodiment of the present disclosure. Initially, the phone 70 is ready for incoming and outgoing calls (mode 1001). There is an incoming call (event 1a), and consequently the digital information device 10 controls the local phone 70 to ring in order to notify the local user (mode 1002). Afterwards, the digital information device 10 determines if the incoming call is accepted by the local user. If the incoming call remains unanswered (event 2a), the phone 70 is once again ready to accept incoming calls or transmit outgoing calls (mode 1001). If the incoming call is accepted by the local user, the digital information device 10 determines if the remote controller 50 or the phone 70 is selected to process the incoming call (event C).

If the remote controller 50 is selected to process the incoming call (event 4a), the digital information device 10 turns on the video mode and communicates with the remote user with the audio and video on (mode 1004).

If the phone 70 is selected to process the incoming call (event 3a), the digital information device 10 turns off the video mode and communicates with the remote user with only the audio on (mode 1003). Simultaneously, the digital information device 10 displays a dialog (event 5a) to inquire the local user if the video mode needs to be turned on (mode 1005). If the video mode needs to be turned on (event 7a), the digital information device 10 turns on the video mode and communicates with the remote user with the audio and video on (mode 1004). If the video mode does not need to be turned on or the dialog times out (event 6a), the digital information device 10 communicates with the remote user with only the audio on (mode 1003).

The video mode can be switched on and off by pressing the video switching button of the remote controller 50 (events 8a and 9a).

The local user hangs up the phone 70 (event 10a or 11a), and subsequently the phone 70 is once again ready for receiving incoming calls or transmitting outgoing calls (mode 1001).

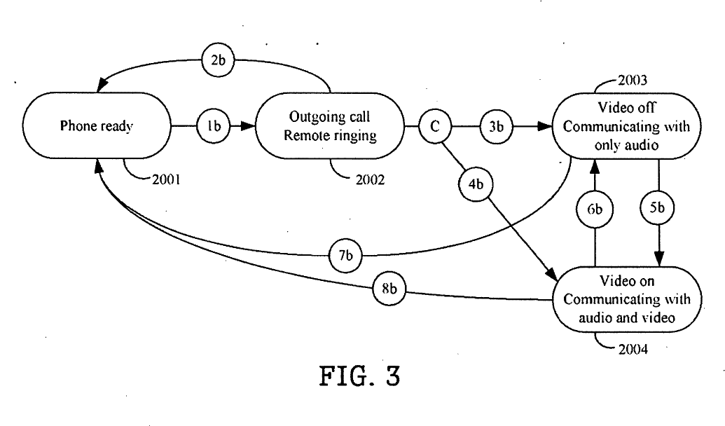

FIG. 3 is a schematic diagram showing mode changes in processing an outgoing call according to another embodiment of the present disclosure. Initially, the phone 70 is ready for incoming and outgoing calls (mode 2001). The local user dials an outgoing call (event 1b), and consequently a remote phone rings in order to notify the remote user of the call (mode 2002). Afterwards, the digital information device 10 determines if the outgoing call is accepted by the remote user. If the outgoing call is not accepted by the remote user (event 2b), the phone 70 is once again ready for receiving incoming calls and transmitting outgoing calls (mode 2001). If the outgoing call is accepted by the remote user, the digital information device 10 determines if the remote controller 50 or the phone 70 is selected to process the outgoing call (event C).

If the remote controller 50 is selected to process the outgoing call (event 4b), the digital information device 10 turns on the video mode and communicates with the remote user with the audio and video on (mode 2004).

If the phone 70 is selected to process the outgoing call (event 3b), the digital information device 10 turns off the video mode and communicates with the remote user with only the audio on (mode 2003).

The video mode can be switched on and off by pressing the video switching button of the remote controller 50 (events 5b and 6b).

The local user hangs up the phone 70 (event 7b or 8b), and subsequently the phone 70 is once again ready for receiving incoming calls and transmitting outgoing calls (mode 2001).

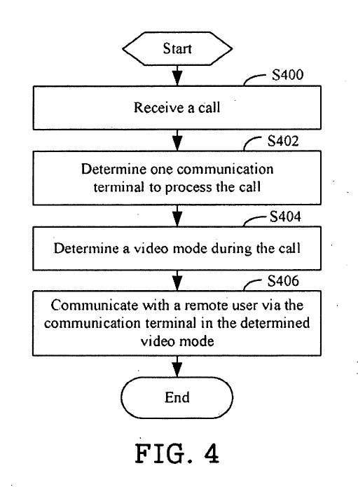

FIG. 4 is a flowchart of a method for processing calls according to one embodiment of the present disclosure.

In block S400, the digital information device 10 receives a call. In one embodiment, the digital information device 10 may receive an incoming call from a remote user or receive an outgoing call request from the local user.

In block S402, the digital information device 10 determines one communication terminal to process the call. In one embodiment, the communication terminal includes the remote controller 50 and the phone 70.

In block S404, the digital information device 10 determines a video mode during the call.

In block S406, the digital information device 10 communicates with the remote user via the communication terminal in the determined video mode.

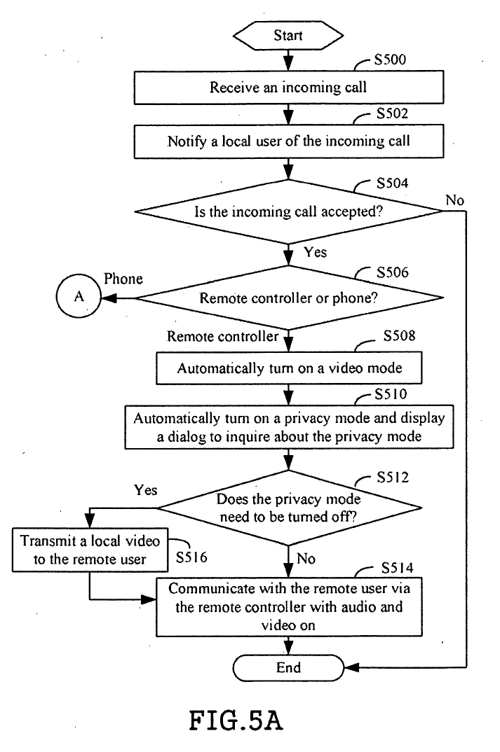

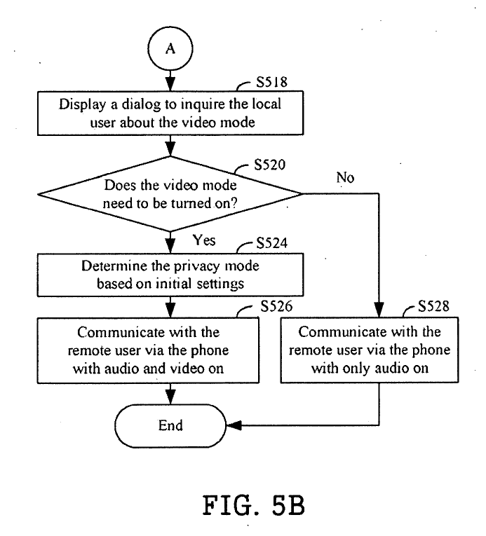

FIGS. 5A and 5B are flowcharts of a method for processing calls according to another embodiment of the present disclosure.

In block S500, the transceiving module 100 receives an incoming call from the remote user via the communication network 80.

In block S502, the reminding module 106 notifies the local user of the incoming call. In one embodiment, the reminding module 106 makes the phone 70 ring in order to notify the local user of the incoming call when the transceiving module 100 receives the incoming call from the local user through the communication network 80.

The reminding module 106 is not restricted to notifying the local user of an incoming call via the phone 70. The reminding module 106 may also notify the local user of the incoming call via the video outputting device 40 or the audio outputting device 20.

In block S504, the call processing module 102 determines if the incoming call is accepted by the local user.

If the incoming call is accepted by the local user, in block S506, the call processing module 102 determines if the remote controller 50 or the phone 70 is selected to process the incoming call.

If the remote controller 50 is selected to process the incoming call, the video processing module 104 automatically turns on the video mode.

In block S510, the video processing module 104 automatically turns on the privacy mode and displays a dialog to inquire the local user if the privacy mode needs to be turned off.

In block S512, the video processing module 104 determines if the privacy mode needs to be turned off according to a response from the local user.

If the privacy mode needs to be turned off, in block S516, the video processing module 104 transmits a local video to the remote user.

In block S514, the call processing module 102 communicates with the remote user via the remote controller 50 with the audio and video on. In one embodiment, the call processing module 102 communicates with the remote user via the remote controller 50, the audio input device 30, the audio output device 20, the video input device 60, and the video output device 40 with the audio and video on.

If the phone 70 is selected to process the incoming call, in block S518, the video processing module 104 displays a dialog to inquire the local user if the video mode needs to be turned on.

In block S520, the video processing module 104 determines if the video mode needs to be turned on according to a response from the local user.

In block S524, the video processing module 104 determines the privacy mode based on initial settings if the video mode needs to be turned on.

In block S526, the call processing module 102 communicates with the remote user via the phone 70 with the audio and video on. In one embodiment, the call processing module 102 communicates with the remote user via the phone 70, the video input device 60, and the video output device 40 with the audio and video on.

In block S528, the call processing module 102 communicates with the remote user via the phone 70 with only the audio on if the video mode does not need to be turned on.

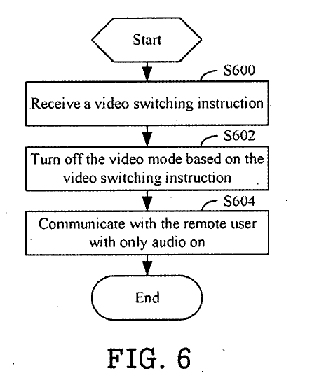

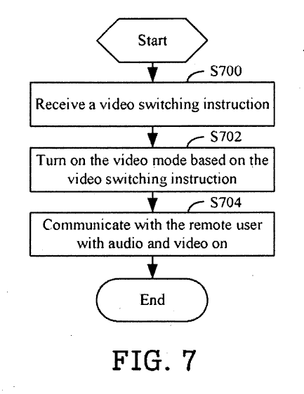

In blocks S514, S526, and S528, the video processing module 104 may switch the current video mode on and off via flowcharts in FIGS. 6-7. For instance, the video processing module 104 may turn off the current video mode via the flowchart in FIG. 6 when the current video mode is on. The video processing module 104 may turn on the current video mode via the flowchart in FIG. 7 when the current video mode is off.

FIG. 6 is a flowchart of a method for switching video modes according to one embodiment of the present disclosure. In this embodiment, the current video mode is on, and the call processing module 102 communicates with the remote user with the audio and video on.

In block S600, the video processing module 104 receives a video switching instruction.

In block S602, the video processing module 104 turns off the video mode according to the video switching instruction.

In block S604, the call processing module 102 communicates with the remote user with only the audio on.

FIG. 7 is a flowchart of a method for switching video modes according to another embodiment of the present disclosure. In this embodiment, the current video mode is off, and the call processing module 102 communicates with the remote user with only the audio on.

In block S700, the video processing module 104 receives a video switching instruction.

In block S702, the video processing module 104 turns on the video mode according to the video switching instruction.

In block S704, the call processing module 102 communicates with the remote user with the audio and video on.

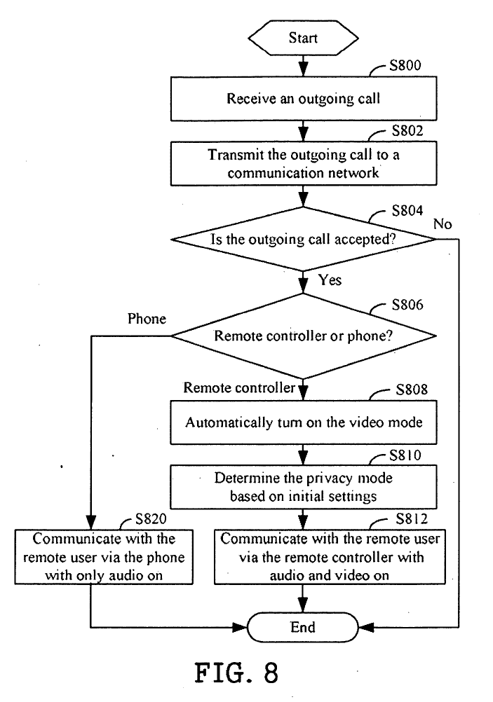

FIG. 8 is a flowchart of a method for processing calls according to a further embodiment of the present disclosure.

In block S800, the transceiving module 100 receives an outgoing call from the remote controller 50 or the phone 70.

In block S802, the transceiving module 100 transmits the outgoing call to the communication network 80.

In block S804, the call processing module 102 determines if the outgoing call is accepted by the remote user.

In block S806, the call processing module 102 determines if the remote controller 50 or the phone 70 is selected to process the outgoing call if the outgoing call is accepted by the remote user.

In block S808, the video processing module 104 automatically turns on the video mode if the remote controller 50 is selected to process the outgoing call.

In block S810, the video processing module 104 determines the privacy mode based on the initial settings.

In block S812, the call processing module 102 communicates with the remote user via the remote controller 50 with the audio and video on. In one embodiment, the call processing module 102 communicates with the remote user via the remote controller 50, the audio input device 30, the audio output device 20, the video input device 60, and the video output device 40 with the audio and video on.

If the phone 70 is selected to process the outgoing call, in block S820, the call processing module 102 communicates with the remote user via the phone 70 with only the audio on.

In blocks S812 and S820, the video processing module 104 could switch the current video mode on and off via flowcharts in FIGS. 6-7. For instance, the video processing module 104 can turn off the current video mode via the flowchart in FIG. 6 when the current video mode is on. The video processing module 104 can turn on the current video mode via the flowchart in FIG. 7 when the current video mode is off.

Therefore, the digital information device 10 provides a convenient way for processing calls with a remote user, either with the remote controller 50 or the phone 70. Additionally, the digital information device 10 provides video service for the local user.

While various embodiments and methods of the present disclosure have been described above, it should be understood that they have been presented by way of example only and not by way of limitation. Thus the breadth and scope of the present disclosure should not be limited by the above-described embodiments, but should be defined only in accordance with the following claims and their equivalents.

What is claimed is:

1. A digital information device for processing calls between a local user and a remote user, the digital information device comprising:
a transceiving module configured for receiving an incoming call from the remote user and transmitting an outgoing call to the remote user;
a video processing module configured for determining a video mode during the incoming call and the outgoing call; and
a call processing module configured for selecting a communication terminal from a remote controller and a phone to process the incoming call and the outgoing call, and communicating with the remote user via the selected communication terminal in the determined video mode.

2. The digital information device as claimed in claim 1, wherein the call processing module is further configured for communicating with the remote user via the remote controller, an audio input device, and an audio output device in the determined video mode upon the condition that the remote controller is selected to process the incoming call and the outgoing call, wherein the call processing module is further configured for communicating with the remote user via the phone in the determined video mode upon the condition that the phone is selected to process the incoming call and the outgoing call.

3. The digital information device as claimed in claim 2, wherein the call processing module is further configured for communicating with the remote user via the selected communication terminal with audio and video on upon the condition that the video mode is on, wherein the call processing module is further configured for communicating with the remote user via the selected communication terminal with only audio on upon the condition that the video mode is off.

4. The digital information device as claimed in claim 3, wherein the video processing module is further configured for receiving a video switching instruction for turning on/off the video mode.

5. The digital information device as claimed in claim 4, wherein the video processing module is further configured for selecting a privacy mode to determine if a local video needs to be transmitted to the remote user.

6. The digital information device as claimed in claim 5, further comprising a reminding module configured for notifying the local user of the incoming call.

7. The digital information device as claimed in claim 6, wherein:
the call processing module is further configured for determining if the incoming call is accepted by the local user and for determining if the remote controller or the phone is selected to process the incoming call upon the condition that the incoming call is accepted by the local user;
the video processing module is further configured for automatically turning on the video mode and the privacy mode upon the condition that the remote controller is selected to process the incoming call, and for inquiring the local user if the video mode needs to be turned on upon the condition that the phone is selected to process the incoming call.

8. The digital information device as claimed in claim 5, wherein:
the transceiving module is further configured for transmitting the outgoing call to a communication network;
the call processing module is further configured for determining if the outgoing call is accepted by the remote user, and determining if the remote controller or the phone is selected to process the outgoing call upon the condition that the outgoing call is accepted by the remote user.

9. The digital information device as claimed in claim 8, wherein the video processing module is further configured for automatically turning on the video mode and determining the privacy mode based on initial settings upon the condition that the remote controller is selected to process the outgoing call, and for turning off the video mode upon the condition that the phone is selected to process the outgoing call.

10. A method for processing calls between a local user and a remote user, comprising:
receiving an incoming call and an outgoing call;
selecting a communication terminal from a remote controller and a phone to process the incoming call and the outgoing call;
determining a video mode during the incoming call and the outgoing call; and
communicating with the remote user via the selected communication terminal in the determined video mode.

11. The method as claimed in claim 10, further comprising:
notifying the local user of the incoming call;
determining if the incoming call is accepted by the local user; and
determining if the remote controller or the phone is selected to process the incoming call if the incoming call is accepted by the local user.

12. The method as claimed in claim 1, wherein the block of determining a video mode during the incoming call comprises:
automatically turning on the video mode if the remote controller is selected to process the incoming call;
automatically turning on a privacy mode and displaying a dialog to inquire the local user if the privacy mode needs to be turned off;
determining if the privacy mode needs to be turned off according to a response from the local user; and
transmitting a local video to the remote user if the privacy mode needs to be turned off.

13. The method as claimed in claim 12, wherein the block of communicating with the remote user via the selected communication terminal in the determined video mode comprises:
communicating with the remote user via the remote controller, an audio input device, an audio output device, a video input device, and a video output device with audio and video on.

14. The method as claimed in claim 1, wherein the block of determining a video mode during the incoming call comprises:
displaying a dialog to inquire the local user if the video mode needs to be turned on if the phone is selected to process the incoming call;
determining if the video mode needs to be turned on according to a response from the local user; and
determining a privacy mode based on initial settings.

15. The method as claimed in claim 14, wherein the block of communicating with the remote user via the selected communication terminal in the determined video mode comprises:
communicating with the remote user via the phone, a video input device, and a video output device with audio and video on if the video mode needs to be turned on according to the response from the local user; and
communicating with the remote user via the phone with only audio on if the video mode does not need to be turned on according to the response from the local user.

16. The method as claimed in claim 10, further comprising:
transmitting the outgoing call to a communication network;
determining if the outgoing call is accepted by the remote user; and
determining if the remote controller or the phone is selected to process the outgoing call.

17. The method as claimed in claim 16, wherein the block of determining a video mode during the outgoing call and communicating with the remote user via the selected communication terminal in the determined video mode comprises:
automatically turning on the video mode if the remote controller is selected to process the outgoing call;
determining a privacy mode based on initial settings; and
communicating with the remote user via the remote controller, an audio input device, an audio output device, a video input device, and a video output device with audio and video on.

18. The method as claimed in claim 17, wherein the block of communicating with the remote user via the selected communication terminal in the determined video mode comprises:
communicating with the remote user via the phone with only audio on if the phone is selected to process the outgoing call.

19. The method as claimed in claim 10, further comprising:
receiving a video switching instruction;
turning off the video mode based on the video switching instruction; and
communicating with the remote user with only audio on.

20. The method as claimed in claim 10, further comprising:
receiving a video switching instruction;
turning on the video mode based on the video switching instruction; and communicating with the remote user with audio and video on.
